(19) United States
(12) Patent Application Publication
(10) Pub. No.: US 2026/0301701 A1
(43) Pub. Date: Oct. 1, 2026

(54) DISPLAY DEVICE AND IMAGE DISPLAY SYSTEM

(71) Applicant: LG Display Co., Ltd., Seoul (KR)

(72) Inventors: Woongjin SEO, Paju-si (KR); DongWoo KANG, Paju-si (KR)

(73) Assignee: LG Display Co., Ltd., Seoul (KR)

(21) Appl. No.: 19/403,552

(22) Filed: Nov. 28, 2025

(30) Foreign Application Priority Data
Mar. 27, 2025 (KR) 10-2025-0039282

(51) Int. Cl. G09G 3/34; G09G 3/36

(52) U.S. Cl. CPC G09G 3/3426; G09G 3/3688; G09G 2320/02; G09G 2320/066; G09G 2320/0686; G09G 2360/144; G09G 2370/08

(57) ABSTRACT

A display device can include a display panel on which a plurality of sub-pixels are disposed to display an image, a backlight unit to supply backlight to the display panel, a data driving circuit to supply a data voltage to the display panel, a backlight control driving circuit to control the backlight unit, and a controller that receives first encoded image data in which dimming data is encoded. The controller further obtains the dimming data and image data based on decoding the first encoded image data, outputs the image data to the data driving circuit, and outputs the dimming data to the backlight control driving circuit.

### CROSS-REFERENCE TO RELATED APPLICATION

This application claims priority to Korean Patent Application No. 10-2025-0039282, filed in the Republic of Korea on March 27, 2025, which is hereby incorporated by reference for all purposes as if fully set forth herein.

### BACKGROUND

### Field

Embodiments of the present disclosure relate to a display device and an image display system.

### Discussion of the Related Art

As the information-oriented society has advanced, various demands for display devices for displaying images have increased, and various types of display devices such as a liquid crystal display (LCD) and an organic light emitting display (OLED) have been utilized.

Among such display devices, an LCD can use a backlight unit as a light source. Because an image having various luminance levels needs to be displayed through the backlight unit, data for controlling the backlight unit can be needed.

### SUMMARY OF THE DISCLOSURE

Embodiments of the present disclosure can provide a display device and an image display system that perform local dimming.

Embodiments of the present disclosure can provide a display device including a controller that receives encoded image data.

The objects of the embodiments of the present disclosure are not limited to those mentioned herein, and other objects not mentioned herein will be clearly understood by those skilled in the art from the description below.

A display device according to embodiments of the present disclosure can include a display panel on which a plurality of sub-pixels are disposed and an image is displayed, a backlight unit supplying backlight to the display panel, a data driving circuit supplying a data voltage to the display panel, a backlight control driving circuit controlling the backlight unit, and a controller supplying image data to the data driving circuit and supplying dimming data to the backlight control driving circuit. The controller can receive first encoded image data in which the dimming data is encoded, obtain the dimming data and the image data based on decoding the first encoded image data, output the image data to the data driving circuit, and output the dimming data to the backlight control driving circuit.

An image display system according to embodiments of the present disclosure can include a display panel on which a plurality of sub-pixels are disposed and an image is displayed, a backlight unit supplying backlight to the display panel, a data driving circuit supplying a data voltage to the display panel, a backlight control driving circuit controlling the backlight unit, a controller supplying image data to the data driving circuit and supplying dimming data to the backlight control driving circuit, and a host system supplying first encoded image data including the dimming data and the image data to the controller. The host system can calculate the dimming data from the image data and obtain the first encoded image data based on encoding the dimming data into the image data.

A display device according to embodiments of the present disclosure can include a display panel on which a plurality of sub-pixels are disposed and an image is displayed, and a controller receiving data for displaying an image on the display panel. The controller can receive image data corresponding to a frame including a black gradation pattern and a white gradation pattern, and within a timing for displaying the frame, the display panel can display the black gradation pattern, but at least part of the received image data corresponding to the black gradation pattern may not have a value corresponding to the black gradation pattern.

According to embodiments of the present disclosure, an image display system including a host system that encodes dimming data can be provided.

According to embodiments of the present disclosure, a display device including a controller that obtains image data and dimming data by decoding encoded image data can be provided.

According to embodiments of the present disclosure, a display device operating with low power consumption can be provided by performing local dimming.

The effects of the embodiments of the present disclosure are not limited to the effects mentioned above, and other effects not mentioned herein will be clearly understood by those skilled in the art from the description of the claims.

### BRIEF DESCRIPTION OF THE DRAWINGS

The present disclosure will be more fully understood from the following detailed description and the accompanying drawings, which are provided for illustrative purposes only and are not intended to limit the present disclosure.

FIG. 1 is a system diagram of an image display system according to various embodiments of the present disclosure.

FIG. 2 is an equivalent circuit diagram of sub-pixels according to various embodiments of the present disclosure.

FIG. 3 is a diagram showing a backlight unit and a display panel according to various embodiments of the present disclosure.

FIG. 4 is a block diagram of an image display system according to various embodiments of the present disclosure.

FIG. 5 is a flowchart of image display operations by a display device according to various embodiments of the present disclosure.

FIG. 6 is a diagram showing timing of image data and dimming data according to various embodiments of the present disclosure.

FIG. 7 is a diagram showing an image not displayed according to a state of a display panel and a state of a backlight unit according to various embodiments of the present disclosure.

FIG. 8 is a diagram showing an image displayed according to a state of a display panel and a state of a backlight unit according to various embodiments of the present disclosure.

FIG. 9 is a flowchart of image display operations including encoding and decoding operations by an image display system according to various embodiments of the present disclosure.

FIG. 10 is a diagram showing an encoding operation of a host system according to various embodiments of the present disclosure.

FIG. 11 is a diagram showing another encoding operation of a host system according to various embodiments of the present disclosure.

FIG. 12 is a diagram showing a decoding operation of a display device according to various embodiments of the present disclosure.

FIG. 13 is a diagram showing another decoding operation of a display device according to various embodiments of the present disclosure.

FIG. 14 is a diagram showing timing of image data and dimming data when a display device receives encoded image data according to various embodiments of the present disclosure.

FIG. 15 is a diagram showing another image displayed according to a state of a display panel and a state of a backlight unit according to various embodiments of the present disclosure.

FIG. 16 is a block diagram of an image display system including a sensor according to various embodiments of the present disclosure.

FIG. 17 is a flowchart of image display operations including encoding and decoding operations of first encoded image data and second encoded image data according to various embodiments of the present disclosure.

FIG. 18 is a diagram showing first encoded image data and second encoded image data according to various embodiments of the present disclosure.

FIG. 19 is a diagram showing encoded image data corresponding to a black gradation pattern displayed on a display device according to various embodiments of the present disclosure.

FIG. 20 is a diagram showing encoded image data corresponding to a black gradation pattern and a white gradation pattern displayed on a display device according to various embodiments of the present disclosure.

### DETAILED DESCRIPTION OF THE EMBODIMENTS

In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present invention, detailed descriptions of well-known functions and components incorporated herein will be omitted when it is determined that the description can make the subject matter in some embodiments of the present invention rather unclear. The terms such as “including”, “having”, “containing”, “constituting” “made up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” can be used herein to describe elements of the present invention. Each of these terms is not used to define essence, order, sequence, or number of elements etc., but is used merely to distinguish the corresponding element from other elements.

When it is mentioned that a first element "is connected or coupled to", “contacts or overlaps” etc. a second element, it should be interpreted that, not only can the first element “be directly connected or coupled to” or “directly contact or overlap” the second element, but a third element can also be "interposed" between the first and second elements, or the first and second elements can "be connected or coupled to", “contact or overlap”, etc. each other via a fourth element. Here, the second element can be included in at least one of two or more elements that "are connected or coupled to", “contact or overlap”, etc. each other.

When time relative terms, such as "after," "subsequent to," "next," "before," and the like, are used to describe processes or operations of elements or configurations, or flows or steps in operating, processing, manufacturing methods, these terms can be used to describe non-consecutive or non-sequential processes or operations unless the term "directly" or "immediately" is used together.

In addition, when any dimensions, relative sizes etc. are mentioned, it should be considered that numerical values for elements or features, or corresponding information (e.g., level, range, etc.) include a tolerance or error range that can be caused by various factors (e.g., process factors, internal or external impact, noise, etc.) even when a relevant description is not specified. Further, the term “can” fully encompasses all the meanings of the term “may” and vice versa.

Hereinafter, various embodiments of the present disclosure will be described in detail with reference to the accompanying drawings. All the components of each display device/apparatus according to all embodiments of the present disclosure are operatively coupled and configured.

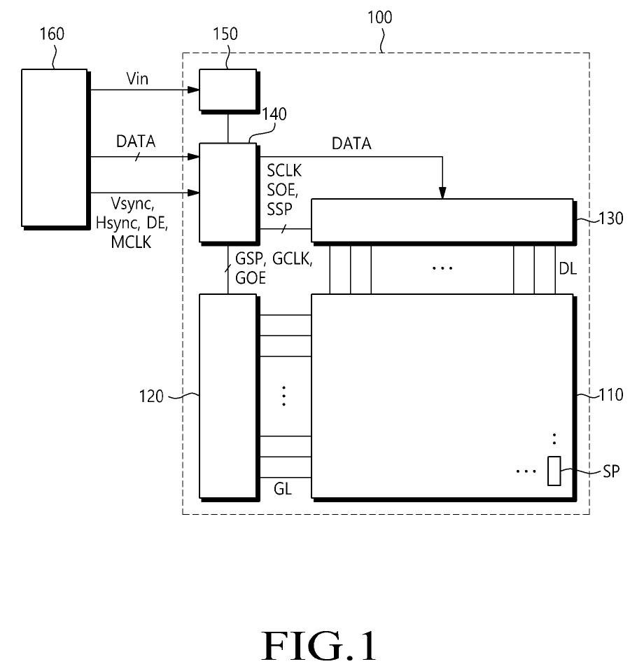

FIG. 1 is a system diagram of an image display system according to various embodiments of the present disclosure.

Referring to FIG. 1, a display device 100 according to one embodiment of the present disclosure can include a display panel 110 in which a plurality of gate lines GL and data lines DL are connected and a plurality of sub-pixels SP are arranged in a matrix form, a gate driving circuit 120 driving the plurality of gate lines GL, a data driving circuit 130 supplying a data voltage through the plurality of data lines DL, a controller 140 controlling the gate driving circuit 120 and the data driving circuit 130, and a power management circuit 150.

The display panel 110 displays an image based on scan signals and light-emission control signals transmitted from the gate driving circuit 120 through the plurality of gate lines GL, and data voltages transmitted from the data driving circuit 130 through the plurality of data lines DL.

In the case of a liquid crystal display, the display panel 110 includes a liquid crystal layer formed between two substrates and can operate in any known mode such as a twisted nematic (TN) mode, a vertical alignment (VA) mode, an in-plane switching (IPS) mode, or a fringe field switching (FFS) mode. In contrast, in the case of an organic light emitting display, the display panel 110 can be implemented in a top emission method, a bottom emission method, or a dual emission method.

The display panel 110 can have a matrix arrangement of a plurality of pixels, and each pixel can include sub-pixels SP of different colors, for example, a white sub-pixel, a red sub-pixel, a green sub-pixel, and a blue sub-pixel. Each sub-pixel SP can be defined by the plurality of data lines DL and the plurality of gate lines GL.

One sub-pixel SP can include a thin film transistor (TFT) formed in an area where one data line DL and one gate line GL intersect, a light-emitting device such as an organic light emitting diode for charging a data voltage, and a storage capacitor for maintaining a voltage in electrical connection with the light-emitting device.

For example, when the display device 100 having a resolution of 2,160 × 3,840 includes four sub-pixels SP of white (W), red (R), green (G), and blue (B), 3,840 data lines DL connected to the four sub-pixels WRGB and 2,160 gate lines GL can be provided, resulting in a total of 3,840 × 4 = 15,360 data lines DL, and each of sub-pixels SP can be disposed at the intersection points of the gate lines GL and the data lines DL.

The gate driving circuit 120 is controlled by the controller 140, and sequentially outputs scan signals to the plurality of gate lines GL disposed in the display panel 110 to control a driving timing of the plurality of sub-pixels SP.

In this case, the gate driving circuit 120 can include one or more gate driving integrated circuits (GDICs). Depending on a driving method, the gate driving circuit 120 can be disposed only on one side of the display panel 110 or on both sides thereof. Alternatively, the gate driving circuit 120 can be embedded in a bezel area of the display panel 110 and implemented in a gate-in-panel (GIP) form.

The data driving circuit 130 receives image data DATA from the controller 140 and converts the received image data DATA into an analog data voltage. Then, in synchronization with the timing at which a scan signal is applied through the gate lines GL, the data driving circuit 130 outputs the data voltage to the respective data lines DL, such that each sub-pixel SP connected to the corresponding data line DL displays a light emission signal having a luminance corresponding to the data voltage. The data driving circuit 130 can be referred to as a data driver.

Similarly, the data driving circuit 130 can include one or more source driving integrated circuits (SDICs). The SDIC can be connected to bonding pads of the display panel 110 in a tape automated bonding (TAB) method or a chip-on-glass (COG) method, or can be directly disposed on the display panel 110.

One side of a source film can be electrically connected to the display panel 110. In addition, wirings for electrically connecting the SDIC to the display panel 110 can be disposed on an upper portion of the source film.

In some cases, each SDIC can be integrated and disposed in the display panel 110. Each SDIC can be implemented in a chip-on-film (COF) method, and in this case, each SDIC can be mounted on the source film and electrically connected to the data lines DL of the display panel 110 through the source film. The SDIC can supply a data voltage to the display panel 110.

The controller 140 supplies various control signals to the gate driving circuit 120 and the data driving circuit 130 and controls operations of the gate driving circuit 120 and the data driving circuit 130. For example, the controller 140 controls the gate driving circuit 120 to output scan signals according to a timing implemented in each frame, and on the other hand, delivers the image data DATA received from outside to the data driving circuit 130.

In this case, the controller 140 receives various timing signals including a vertical synchronization signal (Vsync), a horizontal synchronization signal (Hsync), a data enable signal (DE), and a main clock (MCLK), together with the image data DATA, from an external host system 160.

Alternatively, the controller 140 can receive the image data DATA from the host system 160. For example, the image data DATA can be encoded image data EDATA in which dimming data DD is encoded.

For example, the encoded image data EDATA can include first encoded image data EDATA1 in which dimming data DD is encoded, and second encoded image data EDATA2 in which dimming toggle data, dimming mode data, or dimming block number data is encoded.

The host system 160 can be any one of a television (TV) system, a set-top box, a navigation system, a personal computer (PC), a home theater system, a mobile device, a wearable device, a system-on-chip (SoC), an operating system (OS), or a graphic processing unit (GPU).

Accordingly, the controller 140 generates control signals using the various timing signals received from the host system 160 and delivers the control signals to the gate driving circuit 120 and the data driving circuit 130.

For example, the controller 140 can decode the encoded image data EDATA. The controller 140 can supply the image data DATA and the dimming data DD obtained by decoding the encoded image data EDATA to the data driving circuit 130 and the backlight control driving circuit, respectively. The backlight control driving circuit can be referred to as a backlight control driver. The controller 140 can include a decoding operation module for decoding the first encoded image data EDATA1 or the second encoded image data EDATA2.

For example, in order to control the gate driving circuit 120, the controller 140 outputs various gate control signals including a gate start pulse GSP, a gate clock GCLK, and a gate output enable signal GOE. The gate start pulse GSP controls a timing at which one or more gate driving integrated circuits GDICs constituting the gate driving circuit 120 start operation. The gate clock GCLK is a clock signal commonly input to the one or more gate driving integrated circuits GDICs and controls a shift timing of scan signals. The gate output enable signal GOE designates timing information of the one or more gate driving integrated circuits GDICs.

In addition, in order to control the data driving circuit 130, the controller 140 outputs various data control signals including a source start pulse SSP, a source sampling clock SCLK, and a source output enable signal SOE. The source start pulse SSP controls a timing at which one or more source driving integrated circuits SDICs constituting the data driving circuit 130 start data sampling. The source sampling clock SCLK is a clock signal controlling a timing of sampling data in the SDICs. The source output enable signal SOE controls an output timing of the data driving circuit 130.

The display device 100 can include a power management circuit 150 that supplies various voltages or currents to the display panel 110, the gate driving circuit 120, and the data driving circuit 130, or controls various voltages or currents to be supplied.

The power management circuit 150 adjusts a direct current input voltage (Vin) supplied from the host system 160 to generate power required for driving the display panel 110 and the gate driving circuit 120 and the data driving circuit 130.

Meanwhile, each sub-pixel SP is located at an intersection of a gate line GL and a data line DL, and a light-emitting device can be disposed in each sub-pixel SP. For example, in the case of an organic light emitting display, each sub-pixel SP includes a light-emitting device such as an organic light emitting diode and can display an image by controlling a current flowing through the light-emitting device according to a data voltage.

The display device 100 can be any type of device such as a liquid crystal display, an organic light emitting display, or a plasma display panel.

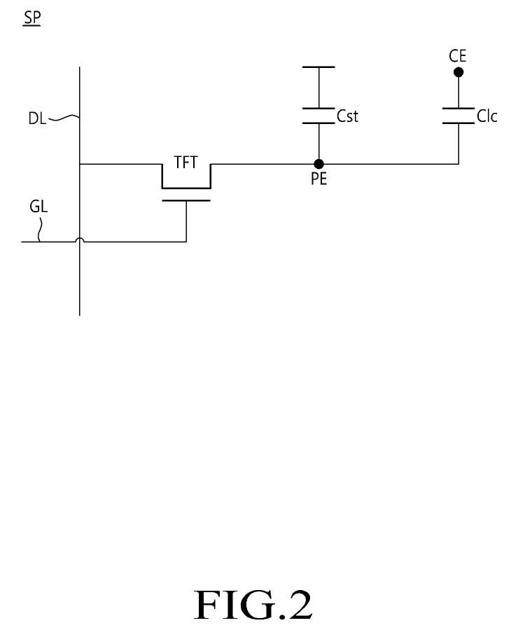

FIG. 2 is an equivalent circuit diagram of a sub-pixel SP according to various embodiments of the present disclosure.

Referring to FIG. 2, the sub-pixel SP can include a thin film transistor TFT, a storage capacitor Cst, and a liquid crystal cell Clc. The liquid crystal cell Clc can include a common electrode CE and a pixel electrode PE.

The thin film transistor TFT is electrically connected to the data line DL, and a gate node of the thin film transistor TFT can be electrically connected to the gate line GL. The thin film transistor TFT can receive a data voltage VDATA from the data line DL.

An electrical connection of the thin film transistor TFT can be controlled by a gate signal supplied from the gate line GL. The gate signal can be determined by a gate control signal GCS.

The liquid crystal cell Clc is driven by a voltage difference between the common electrode CE to which a common voltage is applied and the pixel electrode PE charging the data voltage VDATA, and can implement an image by adjusting an amount of transmitted light. The storage capacitor Cst can maintain a voltage of the liquid crystal cell Clc.

The sub-pixel SP shown in FIG. 2 is merely example, and a sub-pixel SP based on an organic light emitting diode (OLED) or a sub-pixel SP based on quantum dots can be included in the sub-pixels SP of the display device 100.

The number of transistors or the number of capacitors of the sub-pixel SP can vary depending on a type of the display panel 110.

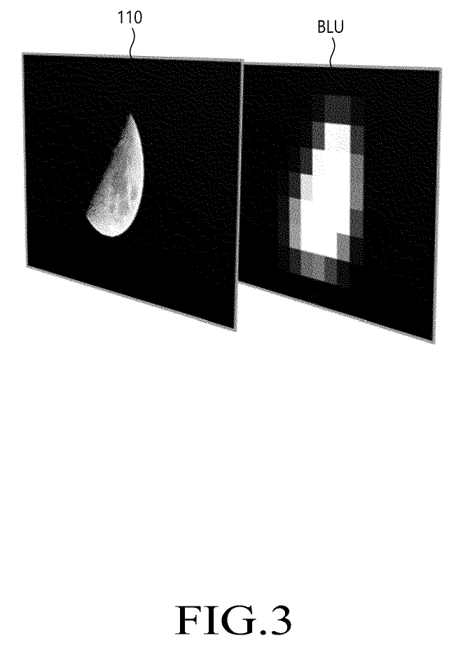

FIG. 3 is a diagram showing a backlight unit BLU and the display panel 110 according to various embodiments of the present disclosure.

Referring to FIG. 3, the display device 100 can include a backlight unit BLU and the display panel 110.

When the display device 100 is a LCD display device, the display panel 110 does not emit light by itself, and an external light source can be required.

In this case, the backlight unit BLU can provide light at a rear surface of the display panel 110.

The backlight unit BLU can include at least one light source such as a cold cathode fluorescent lamp CCFL or a light emitting diode LED to provide light.

The display device 100 can perform local dimming in which a dimming level is adjusted for each area of the backlight unit BLU in order to improve contrast quality of a displayed image.

For example, when both high gradation and low gradation are to be represented in an image, the backlight unit BLU can adjust the dimming level to be high in an area where a high gradation object is displayed, and adjust the dimming level to be low in an area where a low gradation object is displayed.

Hereinafter, an example of driving the display panel 110 and the backlight unit BLU will be described.

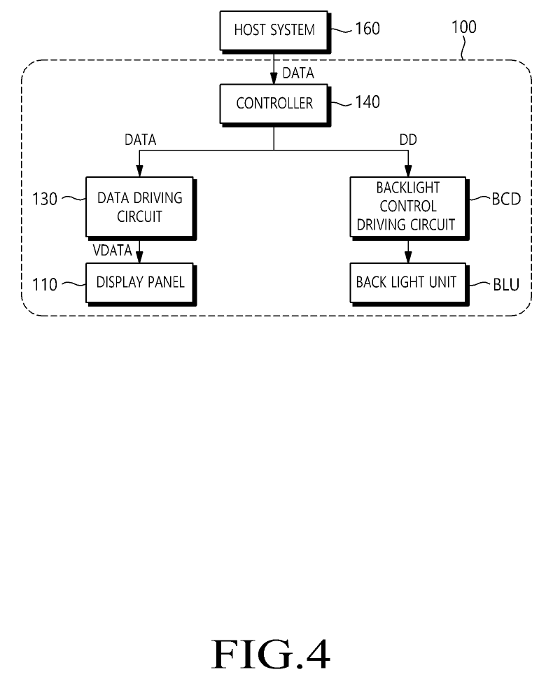

FIG. 4 is a block diagram of an image display system according to various embodiments of the present disclosure.

Referring to FIG. 4, the image display system can include a host system 160, a controller 140, a data driving circuit 130, a display panel 110, a backlight control driving circuit BCD, and a backlight unit BLU.

The host system 160 can supply image data DATA to the controller 140.

The controller 140 can receive the image data DATA from the host system 160.

For example, the controller 140 can calculate dimming data DD from the image data DATA.

For example, the controller 140 can supply the image data DATA to the data driving circuit 130.

For example, the controller 140 can supply the dimming data DD to the backlight control driving circuit BCD.

The data driving circuit 130 can generate a data voltage VDATA corresponding to the received image data DATA. The data driving circuit 130 can supply the generated data voltage VDATA to the display panel 110.

The display panel 110 can display an image based on the supplied data voltage VDATA.

The backlight control driving circuit BCD can control the backlight unit BLU according to the supplied dimming data DD.

The backlight unit BLU can provide light to the display panel 110 as a whole or for each area under the control of the backlight control driving circuit BCD.

Hereinafter, operations for displaying an image after the controller 140 receives the image data DATA from the host system 160 will be described by way of example.

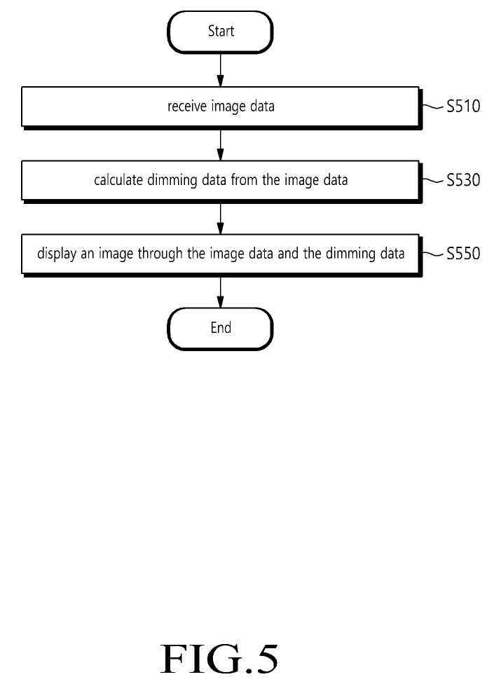

FIG. 5 is a flowchart of image display operations by the display device 100 according to various embodiments of the present disclosure.

Referring to FIG. 5, in operation S510, the controller 140 can receive the image data DATA from the host system 160.

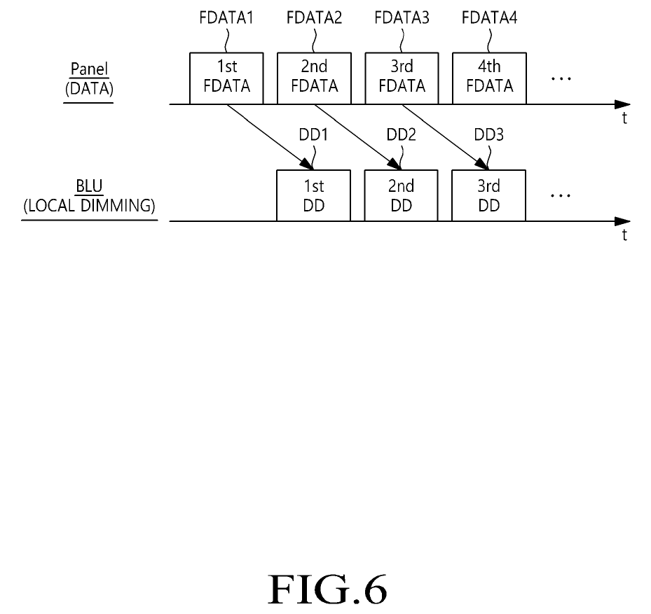

In operation S530, the controller 140 can calculate the dimming data DD from the image data DATA. A detailed description thereof can be given below with reference to FIG. 6.

In operation S550, the display device 100 can display an image through the image data DATA and the dimming data DD.

For example, when the controller 140 provides the image data DATA to the data driving circuit 130 and provides the dimming data DD to the backlight control driving circuit BCD, the data driving circuit 130 can provide the data voltage VDATA to the display panel 110, and the backlight control driving circuit BCD can control dimming of the backlight unit BLU. Accordingly, a gradation of the display panel 110 is adjusted, and dimming of the backlight unit BLU is controlled, so that an image can be displayed.

Hereinafter, an operation of calculating the dimming data DD from the image data DATA will be described by way of example.

FIG. 6 is a diagram showing timing of the image data DATA and the dimming data DD according to various embodiments of the present disclosure.

Referring to FIG. 6, the image data DATA can include a plurality of frame image data (FDATA1, FDATA2, FDATA3, FDATA4 …) respectively corresponding to a plurality of frames. The dimming data DD can include a plurality of dimming data (DD1, DD2, DD3 …) respectively corresponding to the plurality of frame image data (FDATA1, FDATA2, FDATA3, FDATA4 …).

The controller 140 can calculate the plurality of dimming data (DD1, DD2, DD3 …) respectively corresponding to the plurality of frame image data (FDATA1, FDATA2, FDATA3, FDATA4 …).

For example, the controller 140 can calculate the dimming data DD by using a Hough transform, image segmentation, a linear transformation, a nonlinear transformation, an adjacent block influence function, or a low-gradation area image data compensation method.

For example, when the low-gradation area image data compensation method is used to lower a dimming level in a low-gradation area and increase the image data DATA through data compensation, power consumption of the display device 100 can be reduced.

For example, the controller 140 can control a level of movement of a halo occurring as an object moves by using the adjacent block influence function.

For example, the controller 140 can improve high-gradation representation capability by using the nonlinear transformation to increase a dimming level as an area in the image has a higher gradation.

For example, the controller 140 can calculate first dimming data DD1 through first frame image data FDATA1. For example, the controller 140 can calculate the first dimming data DD1 such that a high dimming level and a low dimming level are respectively applied to areas of the backlight unit BLU corresponding to high-gradation areas and low-gradation areas in the first frame image data FDATA1.

For example, the controller 140 can calculate second dimming data DD2 through second frame image data FDATA2. For example, the controller 140 can calculate the second dimming data DD2 such that a high dimming level and a low dimming level are respectively applied to areas of the backlight unit BLU corresponding to high-gradation areas and low-gradation areas in the second frame image data FDATA2.

For example, the controller 140 can calculate third dimming data DD3 through third frame image data FDATA3. For example, the controller 140 can calculate the third dimming data DD3 such that a high dimming level and a low dimming level are respectively applied to areas of the backlight unit BLU corresponding to high-gradation areas and low-gradation areas in the third frame image data FDATA3.

In this case, a point in time at which Nth dimming data DDN controls the backlight unit BLU can be a point in time at which an image corresponding to (N+1)th frame image data (FDATAN+1) is displayed on the display panel 110. For example, a delay of one frame can occur due to a period for the controller 140 to calculate the dimming data DD.

Hereinafter, an example in which an image is displayed with a delay will be described.

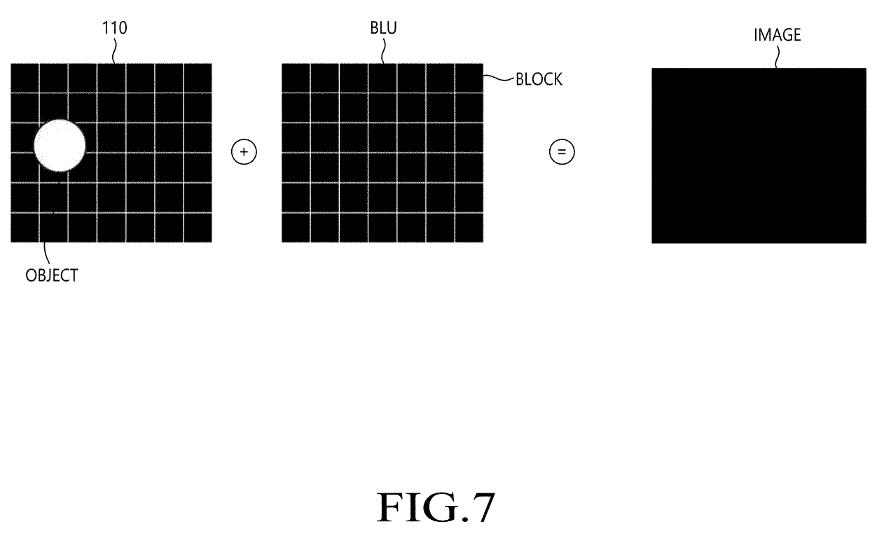

FIG. 7 is a diagram showing an image IMAGE not displayed according to a state of the display panel 110 and a state of the backlight unit BLU according to various embodiments of the present disclosure.

Referring to FIG. 7, a predetermined object OBJECT can be displayed on the display panel 110. The backlight unit BLU can include a plurality of blocks BLOCKs.

For example, the object OBJECT can correspond to a high-gradation area in the display panel 110.

The display device 100 can control the object OBJECT and an area in the backlight unit BLU having a high dimming level to overlap with each other in order to perform local dimming.

However, when the dimming data DD is delayed with respect to the frame image data FDATA, the image IMAGE may not be displayed.

For example, in FIG. 7, the display panel 110 can be controlled by the first frame image data FDATA1, and the backlight unit BLU may not be controlled by the dimming data DD.

Accordingly, at a timing when the first frame image data FDATA1 is displayed as the image IMAGE, because the calculated dimming data DD is not present, the image IMAGE may not be displayed. In other words, because there is no light source of the backlight unit BLU controlled by the dimming data DD, the image IMAGE may not be displayed.

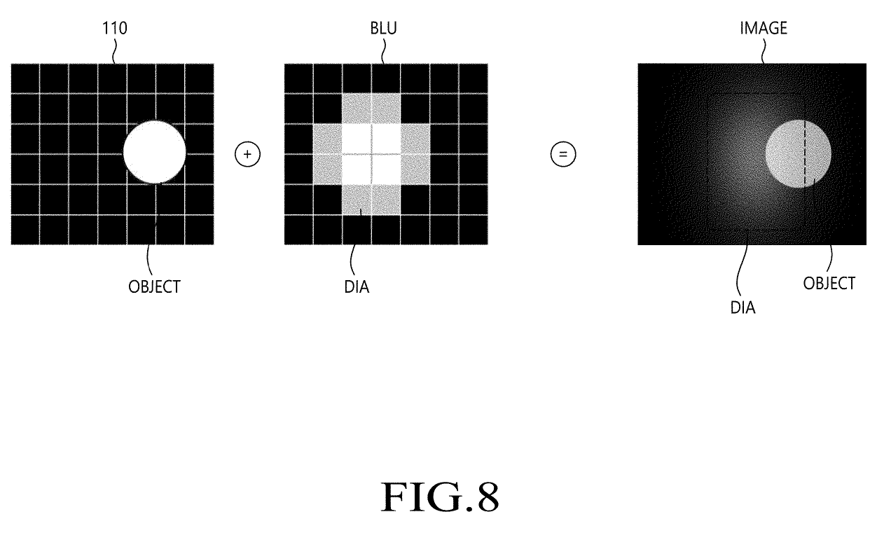

FIG. 8 is a diagram showing an image IMAGE displayed according to a state of the display panel 110 and a state of the backlight unit BLU according to various embodiments of the present disclosure.

Referring to FIG. 8, a predetermined object OBJECT can be displayed on the display panel 110. The backlight unit BLU can include a dimming area DIA.

The object OBJECT can be a high-gradation area in the display panel 110, and a remaining area of the display panel 110, excluding the object OBJECT, can be a low-gradation area.

The display device 100 can control the object OBJECT and the dimming area DIA to overlap with each other in order to perform local dimming.

However, when the dimming data DD is delayed with respect to the frame image data FDATA, the object OBJECT may not overlap with the dimming area DIA in the image IMAGE as the object OBJECT is located in a different area from the previous frame image data FDATA.

For example, at a timing when the second frame image data FDATA2 is displayed in the image, because the backlight unit BLU is controlled according to first dimming data DD1 calculated from first frame image data FDATA1, a high-gradation area of the display panel 110 and the dimming area DIA may not match.

The phenomenon shown in FIG. 7 and FIG. 8 can occur due to a period for the controller 140 to calculate the dimming data DD. In order to solve the phenomenon shown in FIG. 7 and FIG. 8, the host system 160 can calculate the dimming data DD and encode the calculated dimming data DD into the image data DATA to supply it to the controller 140.

Accordingly, because the controller 140 does not need to calculate the dimming data DD, a delay of the dimming data DD with respect to the frame image data FDATA can be reduced or minimized.

Hereinafter, an example in which the controller 140 does not calculate the dimming data DD will be described.

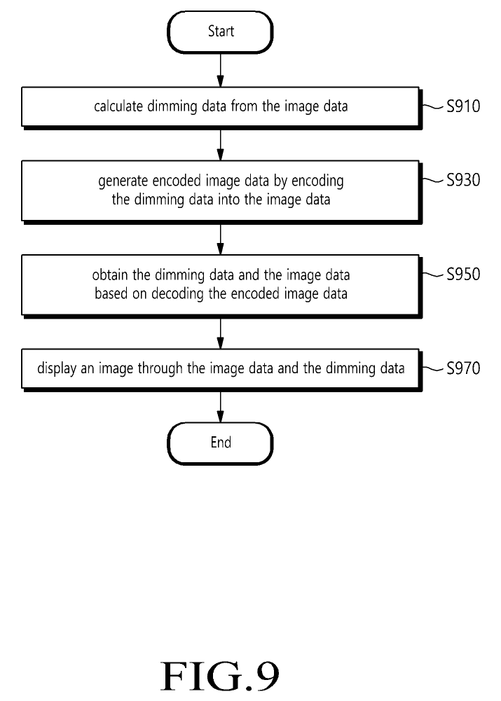

FIG. 9 is a flowchart of image display operations including encoding and decoding operations by an image display system according to various embodiments of the present disclosure.

Referring to FIG. 9, in operation S910, the host system 160 can calculate the dimming data DD from the image data DATA. The operation in which the host system 160 calculates the dimming data DD can be the same as the operation in which the controller 140 calculates the dimming data DD.

In operation S930, the host system 160 can generate encoded image data EDATA by encoding the dimming data DD into the image data DATA. The host system 160 can obtain the encoded image data EDATA by encoding the dimming data DD into the image data DATA.

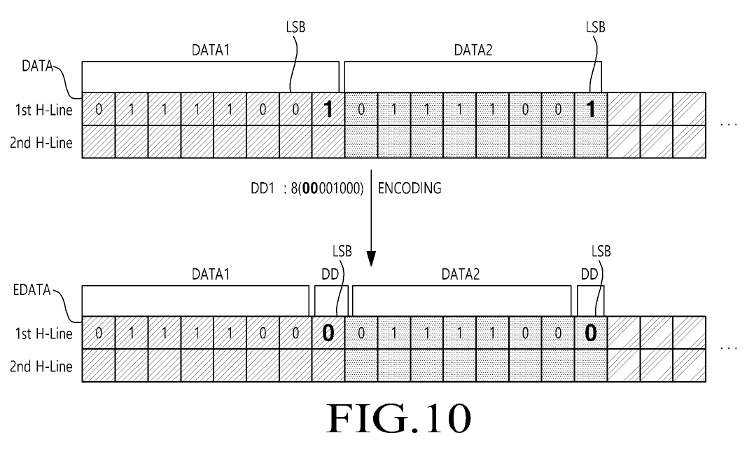

A detailed description thereof can be exemplified in the description below with reference to FIG. 10 and subsequent figures.

As described above, the host system 160 can supply the encoded image data EDATA to the controller 140.

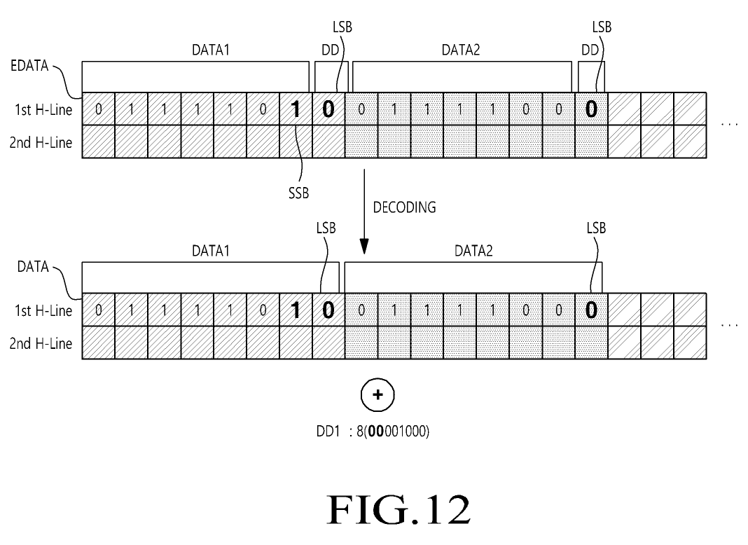

In operation S950, the controller 140 can obtain the dimming data DD and the image data DATA based on decoding the encoded image data EDATA. A detailed description thereof can be exemplified in the description below with reference to FIG. 12 and subsequent figures.

In operation S970, the display device 100 can display an image through the image data DATA and the dimming data DD. The operation S970 can be performed in the same manner as operation S550.

FIG. 10 is a diagram showing an encoding operation of the host system 160 according to various embodiments of the present disclosure.

Referring to FIG. 10, the host system 160 can obtain encoded image data EDATA by including the dimming data DD in a least significant bit LSB of the image data DATA.

The encoded image data EDATA can include the image data DATA and the dimming data DD. For example, encoded image data EDATA corresponding to a first sub-pixel can be data including first image data DATA and at least a portion of the dimming data DD.

The host system 160 can generate encoded image data EDATA by including the dimming data DD in a least significant bit LSB of the image data DATA.

For example, first dimming data DD1 calculated by the host system 160 can be composed of 8 bits and can have a value of 8. In this case, the first dimming data DD1 can be represented as “00001000”.

For example, the host system 160 can sequentially encode the first dimming data DD1 into LSBs of the image data DATA corresponding to a plurality of sub-pixels in a first horizontal line. Hereinafter, an operation of encoding the first two digits of “00001000” will be exemplified.

For example, the host system 160 can replace a value of 1 in a least significant bit LSB of first image data DATA1 corresponding to a first sub-pixel in a first horizontal line of the display panel 110 with a value of 0. Alternatively, the host system 160 can include the dimming data DD in the LSB of the first image data DATA1. Accordingly, a data set in which the dimming data DD is included in the LSB of the image data DATA can be referred to as encoded image data EDATA.

For example, the host system 160 can replace a value of 1 in an LSB of second image data DATA2 corresponding to a second sub-pixel adjacent to the first sub-pixel with a value of 0.

For example, when the number of blocks of the backlight unit BLU is 80 and the dimming data DD corresponding to each block is composed of 8 bits, the host system 160 can encode the dimming data DD corresponding to the 80 blocks into the LSBs of the image data DATA corresponding to 640 sub-pixels, which is 80 × 8.

For example, in the display device 100 having a resolution of 2,160 × 3,840, the host system 160 can store the entire dimming data DD in the first horizontal line. In this case, because only the image data DATA of sub-pixels corresponding to a left region of the first horizontal line is encoded, a display area in the display panel 110 affected by encoding and decoding can be relatively small. Accordingly, the display device 100 can resolve a delay in the timing of the dimming data DD while reducing or minimizing image quality deterioration.

However, the number of bits constituting the dimming data DD can vary depending on the resolution of the dimming data DD. Accordingly, the dimming data DD can be stored up to an Nth horizontal line.

Because the LSB of the image data DATA has the lowest weight, deformation of the image data DATA can be reduced or minimized. Accordingly, image deterioration may not be visually perceived.

Hereinafter, a method of reducing or minimizing loss of image data DATA by using an average value between two adjacent sub-pixels to further reduce minimize image deterioration will be exemplified.

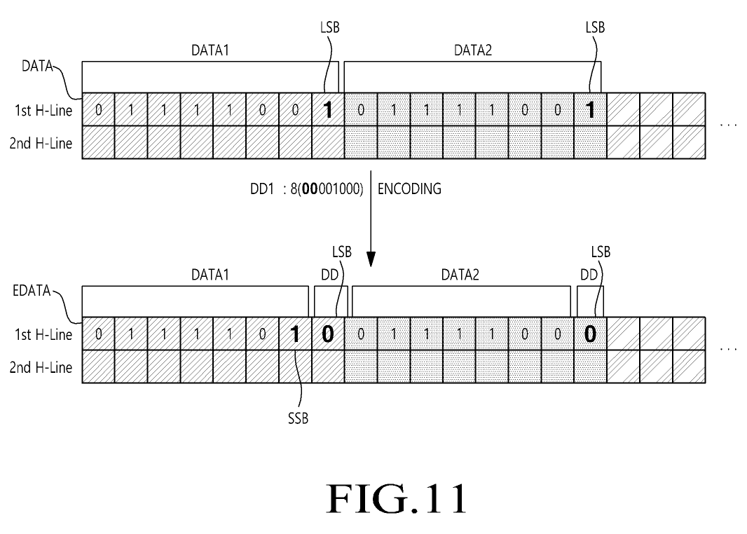

FIG. 11 is a diagram showing another encoding operation of the host system 160 according to various embodiments of the present disclosure.

Referring to FIG. 11, the host system 160 can encode the dimming data DD into LSBs of image data DATA of a plurality of sub-pixels SP.

For example, the host system 160 can perform encoding such that an average value of the image data DATA and the encoded image data EDATA in units of two sub-pixels is the same.

For example, the host system 160 can perform encoding such that an average value of the first image data DATA1 and the second image data DATA2 before encoding matches an average value of the data including the first image data DATA1 and the dimming data DD and the data including the second image data DATA2 and the dimming data DD after encoding.

For example, the average value of the first image data DATA1 and the second image data DATA2 before encoding can be 121. For example, the average value of the data including the first image data DATA1 and the dimming data DD and the data including the second image data DATA2 and the dimming data DD after encoding can be 120.

In this case, the host system 160 can change a value in a second significant bit SSB of data including the first image data DATA1 corresponding to the first sub-pixel and the dimming data DD from 0 to 1, thereby changing an average value to 121.

In other words, in order to make an average value of encoded image data EDATA corresponding to an Nth sub-pixel and encoded image data EDATA corresponding to an (N+1)th sub-pixel equal to an average value of Nth image data (DATAN) corresponding to the Nth sub-pixel and (N+1)th image data (DATAN+1) corresponding to the (N+1)th sub-pixel before encoding, the host system 160 can increase or decrease a value of the encoded image data EDATA corresponding to the Nth sub-pixel or the encoded image data EDATA corresponding to the (N+1)th sub-pixel.

Hereinafter, an example in which the controller 140 receives and decodes the above-described encoded image data EDATA will be described.

FIG. 12 is a diagram showing a decoding operation of the display device 100 according to various embodiments of the present disclosure.

Referring to FIG. 12, the controller 140 can decode the encoded image data EDATA by extracting a value in an LSB of the encoded image data EDATA.

Accordingly, the controller 140 can obtain the image data DATA and the dimming data DD. The image data DATA can be data of the encoded image data EDATA after the LSB is extracted. The dimming data DD can be data in which the values in the extracted LSBs are combined. The number of combinations can vary depending on the number of bits of the dimming data DD.

For example, as the controller 140 decodes the encoded image data EDATA corresponding to two sub-pixels, the controller 140 can obtain, from data of two pieces of image data EDATA corresponding to the two sub-pixels and each composed of 8 bits and dimming data DD composed of 8 bits, at least a portion of 2 bits of the dimming data DD .

In this case, the controller 140 can obtain the image data without changing the second significant bit SSB of the encoded image data EDATA.

Referring again to FIG. 11, before encoding, a value of the first image data DATA1 can be 121, and a value of the second image data DATA2 can be 121.

Referring again to FIG. 12, after decoding, a value of the first image data DATA1 can be 122, and a value of the second image data DATA2 can be 120.

Accordingly, an average value of the image data DATA corresponding to two adjacent sub-pixels before encoding and an average value of the image data DATA corresponding to two adjacent sub-pixels after decoding can be the same.

Hereinafter, an operation of the controller 140 for reducing or minimizing a value difference of the image data DATA corresponding to two adjacent sub-pixels after decoding will be exemplified.

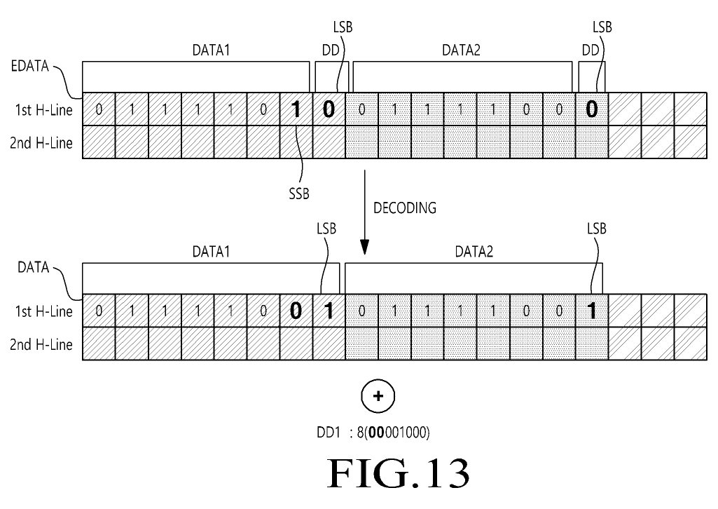

FIG. 13 is a diagram showing another decoding operation of the display device 100 according to various embodiments of the present disclosure.

In the description of FIG. 13, explanations overlapping with those of FIG. 12 can be omitted or may be briefly provided.

Referring to FIG. 13, the controller 140 can obtain the image data DATA and the dimming data DD by extracting LSBs of the encoded image data EDATA.

For example, the encoded image data EDATA of FIG. 13 can be data obtained by encoding the image data DATA of FIG. 11.

In this case, the controller 140 can change the respective values of two image data EDATA while decoding the encoded image data EDATA. The two image data DATA can be image data between adjacent sub-pixels. The controller 140 can change the respective values of the two image data DATA such that the average value of the two image data DATA after decoding becomes the same.

In other words, the controller 140 can obtain at least a portion of the dimming data DD, the first image data DATA1 corresponding to the first sub-pixel, and the second image data DATA2 corresponding to a second sub-pixel adjacent to the first sub-pixel.

Subsequently, the controller 140 can change the value of the first image data and the value of the second image data, respectively, to the average value of the first image data DATA1 and the second image data DATA2.

For example, after extracting the LSB values of the encoded image data EDATA corresponding to two sub-pixels as the dimming data DD, the controller 140 can change a value of the SSB of the encoded image data EDATA corresponding to the first sub-pixel from 1 to 0 and the value of the LSB from 0 to 1, respectively, and change the LSB value of the encoded image data EDATA corresponding to the second sub-pixel from 0 to 1.

In other words, after decoding a value of 2 that has been increased through encoding, the controller 140 can reduce or minimize a difference between first image data DATA1 and second image data DATA2 by dividing the value into 1 for the first image data DATA1 and 1 for the second image data DATA2.

The foregoing method can be equally applied even when the host system 160 decreases the value of the encoded image data EDATA through encoding.

However, when a value difference between adjacent sub-pixels SP is large, changing the values of the two sub-pixels to the same average value can result in an output image different from the intended image.

Accordingly, when the value difference between the first image data DATA1 and the second image data DATA2 is greater than or equal to a threshold value, the controller 140 may not change the value of the first image data DATA1 and the value of the second image data DATA2 to the average value.

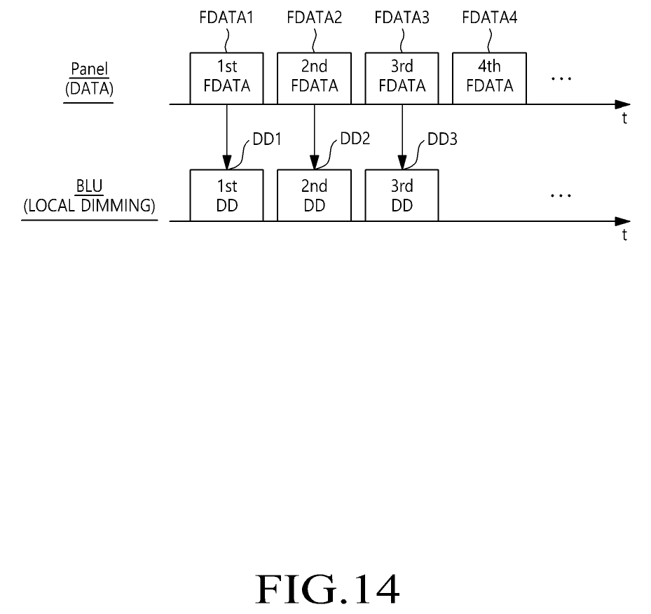

FIG. 14 is a diagram showing the timing of the image data DATA and the dimming data DD when the display device 100 receives the encoded image data EDATA according to various embodiments of the present disclosure.

Referring to FIG. 14, the image data DATA can include a plurality of frame image data (FDATA1, FDATA2, FDATA3, FDATA4, …) each corresponding to a respective frame. The dimming data DD can include a plurality of dimming data (DD1, DD2, DD3, …) each corresponding to the plurality of frame image data (FDATA1, FDATA2, FDATA3, FDATA4, …).

The image data DATA and the dimming data DD in FIG. 14 can be the image data DATA and the dimming data DD obtained from the encoded image data EDATA received from the host system 160.

As the controller 140 does not calculate the dimming data DD, the backlight unit BLU can be controlled within a timing in which the first frame image data FDATA1 is displayed, using first dimming data DD1 calculated from the first frame image data FDATA1.

As the controller 140 does not calculate the dimming data DD, the backlight unit BLU can be controlled within a timing in which the second frame image data FDATA2 is displayed, using second dimming data DD2 calculated from the second frame image data FDATA2.

As the controller 140 does not calculate the dimming data DD, the backlight unit BLU can be controlled within a timing in which the third frame image data FDATA3 is displayed, using third dimming data DD3 calculated from the third frame image data FDATA3.

Hereinafter, an example will be described in which the displayed image is illustrated when the dimming data DD is not delayed with respect to the frame image data FDATA.

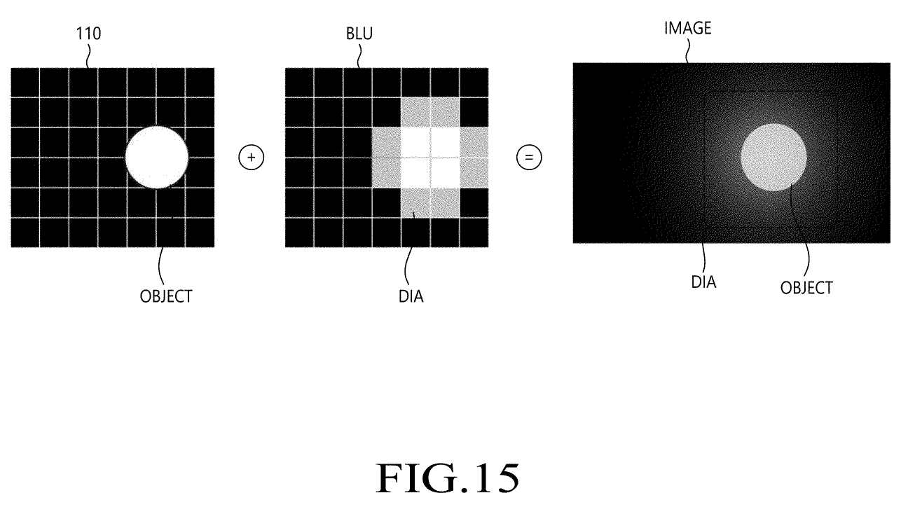

FIG. 15 is a diagram showing another image IMAGE displayed according to a state of the display panel 110 and a state of the backlight unit BLU according to various embodiments of the present disclosure.

In the description of FIG. 15, explanations overlapping with those of FIG. 7 and FIG. 8 can be omitted or may be briefly provided.

Referring to FIG. 15, as an object OBJECT in a high grayscale area within the display panel 110 overlaps with a dimming area DIA in the backlight unit BLU, the expressiveness of the image IMAGE can be improved, and contrast image quality can be enhanced.

Because the dimming data DD has a relatively smaller amount of data than the image data DATA, the image data DATA can further encode other types of data DATA.

Hereinafter, an example of adjusting a dimming level according to illuminance will be described.

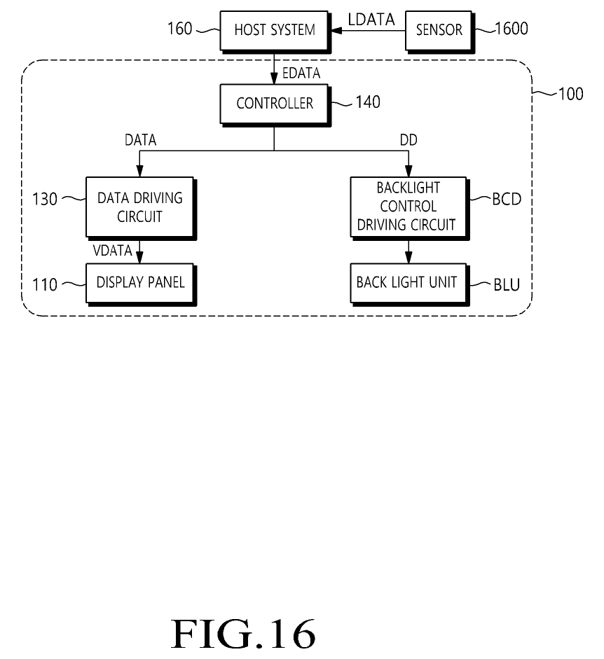

FIG. 16 is a block diagram of an image display system including a sensor 1600 according to various embodiments of the present disclosure.

In the description of FIG. 16, explanations overlapping with those of FIG. 4 can be omitted or may be briefly provided.

Referring to FIG. 16, the image display system can include the sensor 1600, the host system 160, the controller 140, the data driving circuit 130, the display panel 110, the backlight control driving circuit BCD, and the backlight unit BLU.

The sensor 1600 can sense external illuminance to obtain luminance data LDATA.

The sensor 1600 can transmit the luminance data LDATA to the host system 160.

The host system 160 can determine dimming toggle data and dimming mode data using the luminance data LDATA.

The dimming toggle data can be data for determining on/off of dimming.

The dimming mode data can include a dark-room-only algorithm, a low-illuminance-only algorithm, a medium-illuminance-only algorithm, and a high-illuminance-only algorithm. Alternatively, the dimming mode data can include data for selecting at least one among a dark-room-only algorithm, a low-illuminance-only algorithm, a medium-illuminance-only algorithm, and a high-illuminance-only algorithm.

The controller 140 or the backlight control driving circuit BCD can adjust the dimming level using at least one among the dark-room-only algorithm, the low-illuminance-only algorithm, the medium-illuminance-only algorithm, and the high-illuminance-only algorithm.

For example, the controller 140 or the backlight control driving circuit BCD can adjust the dimming level to be higher in a high-illuminance environment and lower in a low-illuminance environment. When the dimming level is high, the backlight unit BLU can provide brighter light, and when the dimming level is low, the backlight unit BLU can provide relatively darker light.

The host system 160 can encode the dimming data, the dimming toggle data, the dimming mode data, and the dimming block number data to obtain the encoded image data EDATA. The dimming block number data can vary depending on a type of the backlight unit BLU. The dimming block number data can be pre-stored in the host system 160.

The host system 160 can supply the encoded image data EDATA to the controller 140.

The controller 140 can decode the encoded image data EDATA to obtain the dimming data DD, the image data DATA, the dimming toggle data, the dimming mode data, and the dimming block number data.

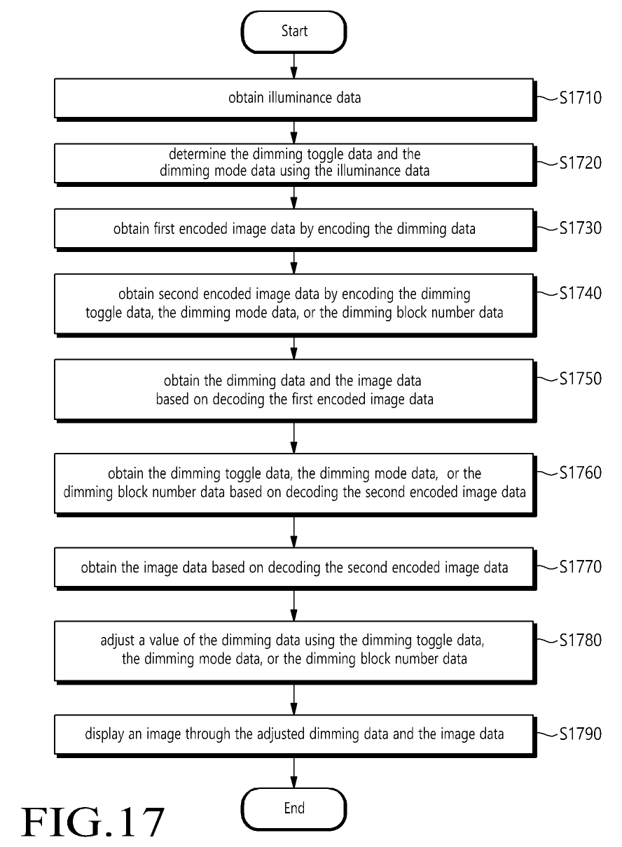

A detailed description thereof can be illustrated in the descriptions of FIG. 17 and subsequent figures.

For example, the controller 140 can supply the image data DATA to the data driving circuit 130.

For example, the controller 140 can supply the dimming data DD, which is adjusted by at least one of the dimming toggle data, the dimming mode data, and the dimming block number data, to the backlight control driving circuit BCD.

The data driving circuit 130 can generate a data voltage VDATA corresponding to the received image data DATA. The data driving circuit 130 can supply the generated data voltage VDATA to the display panel 110.

The display panel 110 can display an image according to the supplied data voltage VDATA.

The backlight control driving circuit BCD can control the backlight unit BLU according to the supplied dimming data DD.

The backlight unit BLU can provide light to the display panel 110 as a whole or on an area-by-area basis under the control of the backlight control driving circuit BCD.

FIG. 17 is a flowchart of image display operations including encoding and decoding operations of first encoded image data EDATA1 and second encoded image data EDATA2 according to various embodiments of the present disclosure.

Referring to FIG. 17, in operation S1710, the sensor 1600 can sense illuminance of an external environment to obtain luminance data LDATA.

The sensor 1600 can provide the luminance data LDATA to the host system 160.

In operation S1720, the host system 160 can determine dimming toggle data and dimming mode data using the luminance data LDATA.

For example, because a higher external illuminance lowers user visibility, the host system 160 may need to adjust the dimming level higher.

Accordingly, in order to adjust the dimming level, dimming toggle data for determining whether dimming is turned on/off and dimming mode data for determining an algorithm required according to an illuminance level can be required. The dimming toggle data and the dimming mode data can be supplied to the controller 140 and can be used to adjust the dimming level.

In operation S1730, the host system 160 can obtain the first encoded image data EDATA1 by encoding the dimming data DD. Operation 1730 can operate in the same manner as operation S950.

In operation S1740, the host system 160 can obtain the second encoded image data EDATA2 by encoding the dimming toggle data, the dimming mode data, or the dimming block number data.

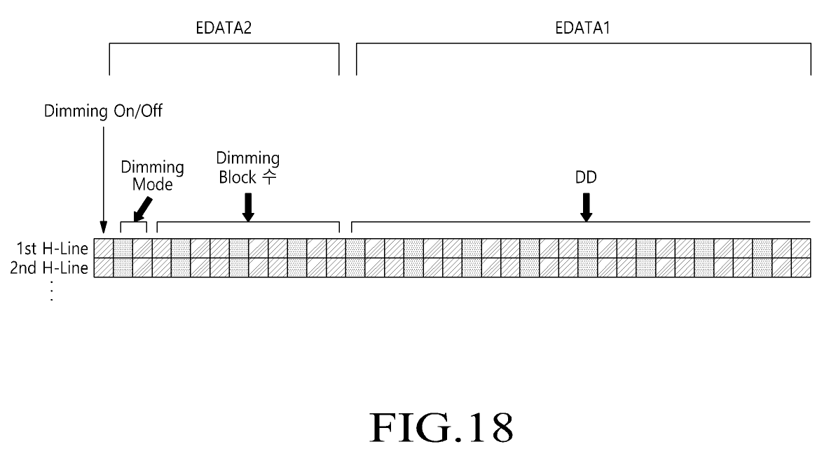

A description thereof can be illustrated in the descriptions of FIG. 18 and subsequent figures.

The host system 160 can supply the first encoded image data EDATA1 and the second encoded image data EDATA2 to the controller 140.

The first encoded image data EDATA1 and the second encoded image data EDATA2 can be encoded in a first horizontal line and a second horizontal line of the image data DATA. Accordingly, even when the image data DATA is encoded, degradation of image quality can be reduced or minimized.

In operation S1750, the controller 140 can obtain the image data DATA and the dimming data DD by decoding the first encoded image data EDATA1. Operation S1750 can operate in the same manner as operation S950.

In operation S1760, the controller 140 can obtain the dimming toggle data, the dimming mode data, or the dimming block number data by decoding the second encoded image data EDATA2.

For example, the controller 140 can obtain the dimming toggle data, the dimming mode data, or the dimming block number data by extracting a value in a least significant bit LSB of the second encoded image data EDATA2.

In operation S1770, the controller 140 can obtain the image data DATA by decoding the second encoded image data EDATA2.

For example, the controller 140 can obtain, as the image data DATA, the data of the second encoded image data EDATA2 after the value in the LSB has been extracted.

In operation S1780, the controller 140 can adjust a value of the dimming data DD using the dimming toggle data, the dimming mode data, or the dimming block number data.

For example, the dimming toggle data can include a value of 0 or 1. When the dimming toggle data has a value of 0, dimming can be turned off, and when it has a value of 1, dimming can be turned on.

For example, the dimming mode data can be used to determine an operating method of dimming. For example, according to the dimming mode data, a function for determining a linear dimming mode, a nonlinear dimming mode, weights, gains, and dimming levels can be changed.

For example, the dimming block number data can be used to determine a stage of dimming or a degree of dimming subdivision.

In operation S1790, the display device 100 can display an image through the adjusted dimming data DD and the image data. Operation S1790 can operate in the same manner as operation S970, except that the controller 140 can supply the adjusted dimming data DD to the backlight control driving circuit BCD.

Hereinafter, the first encoded image data EDATA1 and the second encoded image data EDATA2 can be illustrated.

FIG. 18 is a diagram illustrating the first encoded image data EDATA1 and the second encoded image data EDATA2 according to various embodiments of the present disclosure.

For example, FIG. 18 can be a diagram showing only the LSBs of the first encoded image data EDATA1 or the second encoded image data EDATA2.

Referring to FIG. 18, the encoded image data EDATA can include the first encoded image data EDATA1 and the second encoded image data EDATA2.

The first encoded image data EDATA1 can correspond to data in which the dimming data DD is encoded in the LSB of the image data DATA.

The second encoded image data EDATA2 can correspond to data in which the dimming toggle data, the dimming mode data, or the dimming block number data is encoded in the LSB of the image data DATA.

The controller 140 can extract values in the LSBs of the first encoded image data EDATA1 and the second encoded image data EDATA2 respectively to obtain the dimming data DD, the dimming toggle data, the dimming mode data, or the dimming block number data.

The operation of decoding the first encoded image data EDATA1 and the second encoded image data EDATA2 can be the same as the method described above with reference to FIG. 10 to FIG. 13.

Hereinafter, a phenomenon resulting from the dimming data DD being encoded in the image data DATA corresponding to horizontal lines including a first horizontal line and a second horizontal line can be illustrated.

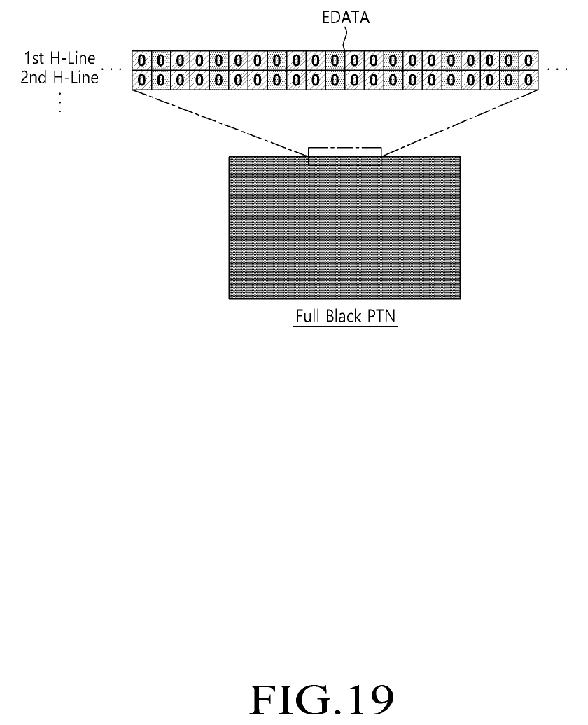

FIG. 19 is a diagram illustrating encoded image data EDATA corresponding to a black gradation pattern displayed on the display device 100 according to various embodiments of the present disclosure.

For example, FIG. 19 can be a diagram showing only the LSBs of the encoded image data EDATA.

Referring to FIG. 19, when only a black gradation pattern is displayed in the display panel 110, the dimming data DD, the dimming toggle data, the dimming mode data, or the dimming block number data can all have a value of 0, as dimming is not required for the backlight unit BLU.

The image data DATA can also have a value of 0.

Hereinafter, an example will be described in which a black gradation pattern is displayed at an upper portion of the display panel 110 and a white gradation pattern is displayed at a lower portion of the display panel 110.

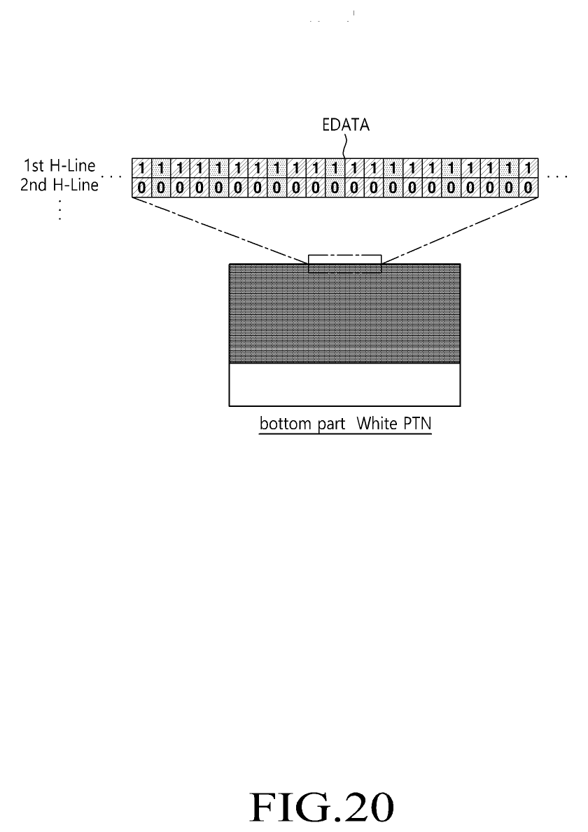

FIG. 20 is a diagram illustrating encoded image data EDATA corresponding to a black gradation pattern and a white gradation pattern displayed on the display device 100 according to various embodiments of the present disclosure.

For example, FIG. 20 can be a diagram showing only the LSBs of the encoded image data EDATA.

Referring to FIG. 20, the controller 140 can receive encoded image data EDATA in which a black gradation pattern is displayed at an upper portion of the display panel 110 and a white gradation pattern is displayed at a lower portion of the display panel 110.

In a frame in which a black gradation pattern is displayed at the upper portion of the display panel 110 and a white gradation pattern is displayed at the lower portion of the display panel 110, because the value corresponding to the black gradation pattern is 0, the image data in the first horizontal line and the second horizontal line can be required to have a value of 0.

However, because the encoded image data EDATA can include the dimming data DD, the dimming toggle data, the dimming mode data, or the dimming block number data for the white gradation pattern to be displayed at the lower portion of the display panel 110, at least some of the encoded image data EDATA corresponding to the black gradation pattern may not have a value of 0.

The encoded image data EDATA can have the same form as the image data DATA. The value corresponding to the black gradation pattern can be 0.

Accordingly, the controller 140 can receive image data DATA corresponding to a frame including the black gradation pattern and the white gradation pattern. During the timing in which the frame is displayed, the display panel 110 can display the black gradation pattern, but at least some of the received image data corresponding to the black gradation pattern may not have the value corresponding to the black gradation pattern.

For example, at least some LSB values of the image data DATA corresponding to the black gradation pattern can have a value of 1.

For example, even though the image data DATA in the first horizontal line and the second horizontal line should have a value of 0, the value may not be 0.

However, it is not intended to exclude cases in which the value of the image data DATA for displaying the black gradation pattern is not 0.

When the value of the image data DATA for displaying the black gradation pattern is a different value, the value can be changed and received by the controller 140.

A display device according to embodiments of the present disclosure can be described as follows.

The display device can include a display panel in which a plurality of sub-pixels are arranged and in which an image is displayed, a backlight unit supplying backlight to the display panel, a data driving circuit supplying a data voltage to the display panel, a backlight control driving circuit controlling the backlight unit, and a controller supplying image data to the data driving circuit and supplying dimming data to the backlight control driving circuit.

The controller can receive first encoded image data in which dimming data is encoded, and, based on decoding the first encoded image data, can obtain the dimming data and the image data, output the image data to the data driving circuit, and output the dimming data to the backlight control driving circuit.

The backlight unit can include a plurality of blocks.

A dimming level of the backlight can be adjusted according to a gradation of a plurality of sub-pixels overlapping with the plurality of blocks.

The controller can obtain at least part of the dimming data by extracting data in the LSB (Least Significant Bit) of the first encoded image data.

The controller can obtain, as the image data, the data of the first encoded image data after the LSB of the first encoded image data is extracted.

After obtaining the image data including at least part of the dimming data, first image data corresponding to a first sub-pixel, and second image data corresponding to a second sub-pixel adjacent to the first sub-pixel, the controller can change the value of the first image data and the value of the second image data respectively to an average value of the first image data and the second image data.

When a difference value between the value of the first image data and the value of the second image data is equal to or greater than a threshold value, the controller may not change the value of the first image data and the value of the second image data to the average value.

The controller can receive second encoded image data in which dimming toggle data, dimming mode data, or dimming block number data is encoded.

The controller can extract data in the LSB of at least part of the second encoded image data to obtain the dimming toggle data, the dimming mode data, or the dimming block number data.

The controller can adjust a value of the dimming data using the dimming toggle data, the dimming mode data, or the dimming block number data.

An image display system can include a display panel in which a plurality of sub-pixels are arranged and in which an image is displayed, a backlight unit supplying backlight to the display panel, a data driving circuit supplying a data voltage to the display panel, a backlight control driving circuit controlling the backlight unit, a controller supplying image data to the data driving circuit and supplying dimming data to the backlight control driving circuit, and a host system supplying first encoded image data including the dimming data and the image data to the controller.

The host system can obtain the first encoded image data based on calculating the dimming data from the image data and encoding the dimming data in the image data.

The image display system can further include a sensor for obtaining illuminance data.

The host system can receive the illuminance data from the sensor.

The host system can determine the dimming toggle data and the dimming mode data using the illuminance data.

The host system can obtain second encoded image data according to encoding the dimming toggle data, the dimming mode data, or the dimming block number data.

The host system can transmit the second encoded image data to the controller.

The controller can receive the first encoded image data in which the dimming data is encoded, and the second encoded image data in which the dimming toggle data, the dimming mode data, or the dimming block number data is encoded.

The controller can extract data in the LSB of at least part of the first encoded image data to obtain the dimming data and the image data.

The controller can extract data in the LSB of at least part of the second encoded image data to obtain the dimming toggle data, the dimming mode data, or the dimming block number data.

The controller can adjust the value of the dimming data using the obtained dimming toggle data, dimming mode data, or dimming block number data.

The controller can supply the adjusted dimming data to the backlight control driving circuit.

The controller can supply the image data to the data driving circuit.

The backlight control driving circuit can control light emission of the backlight unit based on the dimming data.

The data driving circuit can supply the display panel with a data voltage generated based on the image data.

An image can be displayed on the display panel according to the light emission of the backlight unit and the data voltage.

The display device can include a display panel in which a plurality of sub-pixels are arranged and in which an image is displayed, and a controller receiving data for displaying the image on the display panel.

The controller can receive image data corresponding to a frame including a black gradation pattern and a white gradation pattern.

During a timing of displaying the frame, the display panel can display the black gradation pattern, but at least some of the received image data corresponding to the black gradation pattern may not have the value corresponding to the black gradation pattern.

The value of the image data corresponding to the black gradation pattern can be 0.

At least a portion of values of an LSB (Least Significant Bit) in image data corresponding to the black gradation pattern can have a value of 1.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein can be applied to other embodiments and applications without departing from the technical idea and scope of the present disclosure. The above description and the accompanying drawings provide an example of the technical idea of the present disclosure for illustrative purposes only. For example, the disclosed embodiments are intended to illustrate the scope of the technical idea of the present disclosure.

What is claimed is:

1. A display device comprising:
a display panel on which a plurality of sub-pixels are disposed, and configured to display an image;
a backlight unit configured to supply backlight to the display panel;
a data driving circuit configured to supply a data voltage to the display panel;
a backlight control driving circuit configured to control the backlight unit; and
a controller configured to supply image data to the data driving circuit and supply dimming data to the backlight control driving circuit,
wherein the controller is configured to:
receive first encoded image data in which the dimming data is encoded,
obtain the dimming data and the image data based on decoding the first encoded image data,
output the image data to the data driving circuit, and
output the dimming data to the backlight control driving circuit.

2. The display device according to claim 1, wherein the backlight unit comprises a plurality of blocks, and
wherein a dimming level of the backlight is adjusted according to gradations of the plurality of sub-pixels overlapping the plurality of blocks.

3. The display device according to claim 1, wherein the controller is configured to:
obtain at least part of the dimming data by extracting data in a least significant bit (LSB) of the first encoded image data, and
obtain, as the image data, the data of the first encoded image data after the LSB is extracted.

4. The display device according to claim 3, wherein, after obtaining the image data that includes at least part of the dimming data, first image data corresponding to a first sub-pixel, and second image data corresponding to a second sub-pixel adjacent to the first sub-pixel, the controller is configured to change a value of the first image data and a value of the second image data respectively to an average of the value of the first image data and the value of the second image data.

5. The display device according to claim 4, wherein the controller is configured to not change the value of the first image data and the value of the second image data to the average value, when a difference between the value of the first image data and the value of the second image data is equal to or greater than a threshold value.

6. The display device according to claim 1, wherein the controller is configured to:
receive second encoded image data in which dimming toggle data, dimming mode data, or dimming block number data is encoded, and
obtain the dimming toggle data, the dimming mode data, or the dimming block number data by extracting data in at least part of a least significant bit (LSB) of the second encoded image data.

7. The display device according to claim 6, wherein the controller is configured to adjust a value of the dimming data using the dimming toggle data, the dimming mode data, or the dimming block number data.

8. An image display system comprising:
a display panel on which a plurality of sub-pixels are disposed, and configured to display an image;
a backlight unit configured to supply backlight to the display panel;
a data driving circuit configured to supply a data voltage to the display panel;
a backlight control driving circuit configured to control the backlight unit;
a controller configured to supply image data to the data driving circuit and supply dimming data to the backlight control driving circuit; and
a host system configured to supply first encoded image data including the dimming data and the image data to the controller,
wherein the host system is configured to:
calculate the dimming data from the image data, and
obtain the first encoded image data based on encoding the dimming data into the image data.

9. The image display system according to claim 8, further comprising a sensor configured to obtain illuminance data,
wherein the host system is configured to:
receive the illuminance data from the sensor, and
determine dimming toggle data and dimming mode data using the illuminance data.

10. The image display system according to claim 9, wherein the host system is configured to:
obtain second encoded image data by encoding the dimming toggle data, the dimming mode data, or dimming block number data, and
transmit the second encoded image data to the controller.

11. The image display system according to claim 10, wherein the controller is configured to:
receive the first encoded image data in which the dimming data is encoded, and the second encoded image data in which the dimming toggle data, the dimming mode data, or the dimming block number data is encoded,
obtain the dimming data and the image data by extracting data in at least part of a least significant bit (LSB) of the first encoded image data, and
obtain the dimming toggle data, the dimming mode data, or the dimming block number data by extracting data in at least part of an LSB of the second encoded image data.

12. The image display system according to claim 11, wherein the controller is configured to adjust a value of the dimming data using the obtained dimming toggle data, the dimming mode data, or the dimming block number data.

13. The image display system according to claim 12, wherein the controller is configured to:
supply the dimming data having an adjusted value to the backlight control driving circuit, and
supply the image data to the data driving circuit.

14. The image display system according to claim 13, wherein the backlight control driving circuit is configured to control light emission of the backlight unit based on the dimming data,
wherein the data driving circuit is configured to supply the data voltage generated based on the image data to the display panel, and
wherein an image is displayed on the display panel according to the light emission of the backlight unit and the data voltage.

15. A display device comprising:
a display panel on which a plurality of sub-pixels are disposed; and
a controller configured to receive data for displaying an image on the display panel,
wherein the controller is configured to receive image data corresponding to a frame including a black gradation pattern and a white gradation pattern, and
wherein, within a timing for displaying the frame, the display panel is configured to display the black gradation pattern, but at least part of the received image data corresponding to the black gradation pattern does not have a value corresponding to the black gradation pattern.

16. The display device according to claim 15, wherein a value of the image data corresponding to the black gradation pattern is a value of 0, and
wherein at least part of a least significant bit (LSB) value in the image data corresponding to the black gradation pattern has a value of 1.

17. An image display system comprising:
the display device according to claim 15; and
a host system configured to supply first encoded image data including dimming data and the image data to the controller,
wherein the host system is configured to:
calculate the dimming data from the image data, and
obtain the first encoded image data based on encoding the dimming data into the image data.

18. The image display system according to claim 17, further comprising a sensor configured to obtain illuminance data,
wherein the host system is configured to:
receive the illuminance data from the sensor, and
determine dimming toggle data and dimming mode data using the illuminance data.
